(19) United States
(12) Patent Application Publication
(10) Pub. No.: US 2026/0312957 A1
(43) Pub. Date: Oct. 8, 2026

(54) APPLYING CONDITIONAL POLICIES ON A NETWORK

(71) Applicant: Juniper Networks, Inc., Sunnyvale, CA (US)

(72) Inventors: Tejas Sanjeev Panse, San Jose, CA (US); Yuvaraja Mariappan, San Jose, CA (US); Yi Tong Zhuang Zhuo, Milpitas, CA (US); Chitra Kharbanda, San Jose, CA (US)

(21) Appl. No.: 19/098,689

(22) Filed: Apr. 2, 2025

(51) Int. Cl. H04L 9/40

(52) U.S. Cl. CPC H04L 63/102; H04L 63/1425; H04L 63/20

(57) ABSTRACT

This disclosure describes techniques that include applying conditional policies to computing devices on a network to regulate access to network resources. In one example, this disclosure describes a method that includes receiving, by a computing system, information about events occurring on a network; correlating the events to each of a plurality of compute entities on the network; creating a profile, based on the correlated events, for each of the plurality of compute entities; determining, based on the profile and a batch of new events, a threat score for each of the plurality of compute entities; evaluating, based on the threat score for a compute entity of the plurality of compute entities, a conditional policy governing allowed operations for the compute entity; and configuring the network, based on the evaluation, to enforce the conditional policy for the compute entity.

### TECHNICAL FIELD

This disclosure relates to networking, and more specifically, to techniques for managing devices on a network.

### BACKGROUND

Network policies provide a foundation for a secure, efficient, and manageable network. Typically, network administrators conceive of policies that apply to devices on a network, which sometimes involves development of predefined blanket or standardized network policies. These standard policies can make initial configurations for new devices more efficient and streamline network setup and management. As an example, a new employee or member of an organization can be assigned a few blanket or standard policies based on roles, which provide appropriate network access to organizational resources.

### SUMMARY

This disclosure describes techniques for applying conditional policies to computing devices on a network to regulate access to network resources based on an assessment of the likelihood of each computing device being compromised. In particular, techniques described herein may involve developing profiles of virtual machines, user devices, or other computing devices (generally “compute entities”). The profile for a compute entity may enable a system to determine how a particular operation initiated by the compute entity can be categorized. In some examples, operations can be categorized in one of three ways: normal, allowed but anomalous, or restricted. A series of events that are each categorized in this way can be used to determine the likelihood that a given compute entity is compromised (e.g., taken over by a malicious actor). Conditional policies governing certain actions taken by a compute entity may then be applied by disabling (or enabling) those actions based on the determined likelihood that the compute entity is compromised.

As described herein, conditional policies may help administrators to define the criticality of assets and other resources and make it easier for administrators to create more effective policies that ensure that an organization's critical assets are accessed only in appropriate situations. Such techniques may serve as a scalable way to effectively protect access to critical assets without burdening network administrators with manual assessments or configurations.

In some examples, this disclosure describes operations performed by a computing system in accordance with one or more aspects of this disclosure. In one specific example, this disclosure describes a method comprising receiving, by a computing system, information about events occurring on a network; correlating the events, by the computing system, to each of a plurality of compute entities on the network; creating a profile, by the computing system and based on the correlated events, for each of the plurality of compute entities; determining, by the computing system and based on the profile and a batch of new events, a threat score for each of the plurality of compute entities; evaluating, by the computing system and based on the threat score for a compute entity of the plurality of compute entities, a conditional policy governing allowed operations for the compute entity; and configuring the network, by the computing system and based on the evaluation, to enforce the conditional policy for the compute entity.

In another example, this disclosure describes a system comprising a storage system and processing circuitry having access to the storage system, wherein the processing circuitry is configured to carry out operations described herein. In yet another example, this disclosure describes computer-readable storage media comprising instructions that, when executed, configure processing circuitry of a computing system to carry out operations described herein.

The details of one or more examples of the disclosure are set forth in the accompanying drawings and the description herein. Other features, objects, and advantages of the disclosure will be apparent from the description and drawings, and from the claims.

This Summary is intended to provide a brief overview of some of the subject matter described in this document. Accordingly, the above-described features are merely examples and should not be construed to narrow the scope or spirit of the subject matter disclosed herein. Other features, objects, and advantages of the disclosure will be apparent from the description and drawings, and from the claims.

### BRIEF DESCRIPTION OF THE DRAWINGS

FIG. 1 is a conceptual diagram illustrating an example system for applying conditional policies on a network, in accordance with one or more aspects of the present disclosure.

FIG. 2 is a block diagram illustrating an example system for applying conditional policies on a network, in accordance with one or more aspects of the present disclosure.

FIG. 3 is a conceptual diagram illustrating how event scores and threat scores can be calculated from a table of events, in accordance with one or more aspects of the present disclosure.

FIG. 4A illustrates a table showing how threat scores may change over the course of time, in accordance with one or more aspects of the present disclosure.

FIG. 4B illustrates a table showing a different example of how threat scores may change over the course of time, in accordance with one or more aspects of the present disclosure.

FIG. 5 is a flow diagram illustrating operations performed by an example computing system, in accordance with one or more aspects of the present disclosure.

FIGS. 6A-1 and 6A-2 illustrate an example set of system metrics, in accordance with one or more aspects of the present disclosure.

FIG. 6B illustrates an example set of network flow metrics, in accordance with one or more aspects of the present disclosure.

Although each of the above-described Figures are referenced herein in connection with the description of one or more specific examples, such examples are merely illustrative, and each illustration can be used to provide support for other examples not specifically described herein. Accordingly, the one or more examples described herein with reference to any of the above-described Figures should not be construed to narrow the scope or spirit of the subject matter illustrated or otherwise disclosed herein.

### DETAILED DESCRIPTION

To secure a network, reducing the surface area available to attackers is important. A well-conceived set of network policies will tend to reduce the organization's attack surface. However, conventional network policies are static, and once assigned, they allow/deny network communication until they are changed. This poses a unique challenge for high-value or critical assets over the network.

For example, critical assets tend to be protected by limiting access by users. A user seeking access to protected assets or resources typically requires that the user interact with and request approval from network administrators (e.g., the user may “open a ticket” with network administrators). In response, network administrators determine if it is safe for the requesting user to access the protected resource and then allow or deny the request. However, this process is cumbersome and does not work well if network administrators receive frequent requests to access protected resources. Yet users often have a legitimate need to access certain protected resources. For example, employees of an organization need access to certain financial information resources (e.g., pay slips, tax forms, etc.). These financial information resources are critical assets, but requiring network administrators to approve each request by a user to access this information is inefficient and does not scale. Therefore, users are usually provided with relatively unrestricted access to at least some financial information. This solution might work well in many cases, but when the user's device is compromised (e.g., a malicious user or attacker gains access to the user's device), security breaches occur. An attacker that has gained access to a user device may be able to get away with critical employee financial data and more if the finance services themselves have loopholes.

Network threat detection systems can be used to address these potential security breaches by detecting the attacks or security breaches through analysis of available network data. But to detect complex attacks, data from multiple sources needs to be analyzed. This is a complex undertaking, well-suited as background jobs running periodically. However, these background systems have trouble preventing concurrent or near real time access to critical assets if the user's device is compromised.

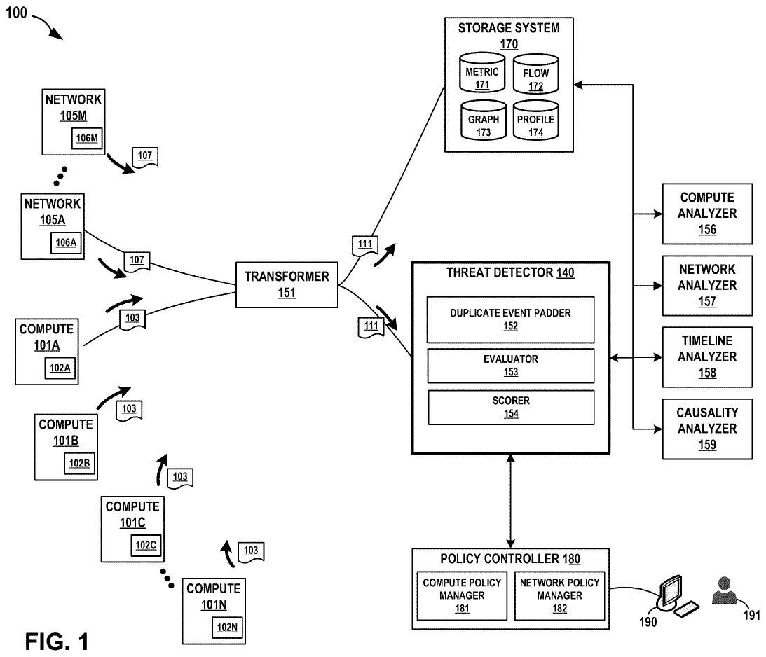

FIG. 1 is a conceptual diagram illustrating an example system for applying conditional policies on a network, in accordance with one or more aspects of the present disclosure. In FIG. 1, conditional policies may apply to one or more of compute entities 101A through 101N (collectively, “compute entities 101,” representing any number of compute entities). These policies control access that each of compute entities 101 has to critical resources and operate to enable access if the requesting source device (e.g., one of compute entities 101) has a low likelihood of being compromised. Using conditional policies tends to automate the network or security administration workflow, because a given compute entity 101 can be automatically granted access to certain protected resources if that compute entity 101 does not show signs of being compromised.

Each of compute entities 101A through 101N (collectively, “compute entities 101,” representing any number of compute entities) may be any appropriate compute node. In general, compute entities 101 may each be any suitable computing system or computing instance including any mobile, non-mobile, wearable, and/or non-wearable computing device, which may be a mobile phone or tablet, or a laptop or desktop computing device. One or more of compute entities 101 may be a virtual machine or other virtualized instance. In many cases, a compute entity 101 is a device or virtual instance that is operated by a user, although techniques described herein may apply to devices or instances that are not necessarily operated by a user.

System 100 of FIG. 1 includes transformer 151, threat detector 140, policy controller 180, and storage system 170. These systems work together to collect, analyze, assess, and evaluate information about operations, events, and/or requests made by any of compute entities 101. To perform such an analysis, threat detector 140 may interact with compute analyzer 156, network analyzer 157, timeline analyzer 158, causality analyzer 159, or other systems. Based on this analysis of operations and requests associated with a given compute entity 101, and further based on policies maintained by policy controller 180, threat detector 140 (or policy controller 180) may selectively limit or enable operations performed within system 100.

In general, each of threat detector 140, storage system 170, policy controller 180, compute analyzer 156, network analyzer 157, timeline analyzer 158, causality analyzer 159, or other systems described herein may be implemented through any suitable computing system. Such computing systems may include one or more server computers, workstations, appliances, cloud computing systems, mainframes, and/or other computing devices that may be capable of performing operations and/or functions described in accordance with one or more aspects of the present disclosure. In other examples, such computing systems may represent or be implemented through one or more virtualized compute instances (e.g., virtual machines, containers) of a data center, cloud computing system, server farm, and/or server cluster.

Both threat detector 140 and storage system 170 receive compute metrics 103 from each of compute entities 101. In some examples, as illustrated in FIG. 1, those compute metrics 103 are treated, processed, and/or transformed by transformer 151 (resulting in processed data 111) before being communicated to storage system 170 and threat detector 140.

Network entity 105A through 105M (collectively, “network entities 105,” and representing any number of network entities) represent components and infrastructure of a network associated with system 100 and governed by policy controller 180. Like compute entities 101, network entities 105 may also output various information (collectively, “network metrics 107”) to both threat detector 140 and storage system 170. In addition to metrics information, network metrics 107 may also include network flow data and other information. As with compute metrics 103, these network metrics 107 may be treated, processed, and/or transformed by transformer 151 prior to being input to storage system 170 and/or threat detector 140.

As described, transformer 151 may process both compute metrics 103 and network metrics 107 to generate a stream of processed information, referred to herein as processed data 111. To generate processed data 111, transformer 151 receives, over a messaging bus, compute metrics 103 from each of compute entities 101 and network metrics 107 from each of network entities 105. Transformer 151 processes the compute metrics 103 and network metrics 107, which may include transforming raw compute metrics 103 and network metrics 107 into data representing a structured format usable by other elements within system 100. Transformer 151 may also perform correlation operations relating to certain network flows. In other words, in some examples, the same network flow (including a source address, destination address, port information, and protocol information) will be emitted by one or more routers or other network entities 105 along the way from a source compute entity 101 to a destination compute entity 101 within system 100. Transformer 151 may correlate these flows and persist them as one record (e.g., in storage system 170) for ease of analytics/storage. Transformer 151 may also aggregate raw metrics from different sources to provide summarized information by, for example, aggregating network flows generated for a network interaction by different network entities. Further, transformer 151 may enrich compute metrics 103 and/or network metrics 107 with metadata or derived information by performing packet analysis to examine the type of data transmitted over the network, including protocols, headers, payloads, and other network traffic details.

Storage system 170 may store processed data 111 in a set of data stores, including metrics data store 171, flow data store 172, graph data store 173, and profile data store 174. Storage system 170 may represent any suitable data structure or storage medium for storing information relating to metrics, flow data, and other information. Storage system 170 receives processed data 111 and stores them across the data stores within storage system 170. Specifically, storage system 170 stores processed data 111 derived from compute metrics 103 primarily within metrics data store 171. Storage system 170 stores processed data 111 derived from network metrics 107 primarily within flow data store 172. Storage system 170 stores information about the structure and/or attributes of the network primarily within graph data store 173 (obtained from network 110, network entities 105, or elsewhere). Storage system 170 stores profile information about each of compute entities 101 (or network entities 105) primarily within profile data store 174 (in some examples, this information is received from compute analyzer 156). The information stored in storage system 170 may be searchable and/or categorized such that one or more systems within system 100 may provide an input requesting information from storage system 170, and in response to the input, receive information stored within storage system 170.

Policy controller 180 manages system and network-related policies for each of compute entities 101 within system 100. Policy controller 180 may be controlled by or operate in response to interactions with administrator computing device 190 (which may be operated by administrator 191). Such interactions may be used to establish, modify, and/or adjust policies maintained by policy controller 180. Such policies may involve policies pertaining to compute entities 101 (managed by compute policy manager 181), network entities 105 (managed by network policy manager 182), or by other elements of system 100.

Threat detector 140 may evaluate operations taking place within system 100 and determine whether or how to apply policies maintained by policy controller 180. To perform such an evaluation, threat detector 140 may interact with various analyzers illustrated in system 100 (i.e., compute analyzer 156, network analyzer 157, timeline analyzer 158, and causality analyzer 159). Such interactions may involve accessing data within storage system 170 and performing analytics to develop a profile of each of compute entities 101 or the users that operate those compute entities 101. In some examples, threat detector 140 queries one or more of these analyzers to calculate a threat score for each of compute entities 101, where the threat score indicates a likelihood that a given compute entity 101 is compromised and/or operated by a malicious actor.

Compute analyzer 156 may analyze system-level metrics associated with compute entities 101. For example, compute analyzer 156 may examine processed data 111 that is derived from compute metrics 103 at regular intervals. Compute analyzer 156 may build a historical compute profile for each of compute entities 101 and modify this profile as needed so that the profile evolves as time progresses. The historical compute profiles can be used to respond to requests from threat detector 140 for information about individual compute entities 101. In some examples, such a profile may be used when responding to a request about a particular compute entity 101, seeking information about the applications that are commonly used by that compute entity 101, about the standard CPU and memory utilization of the compute entity 101, the expected number of processes running on the compute entity 101, and other information. The requested information may differ for various types of compute entities 101. For example, for a compute entity 101 that serves as a database, compute analyzer 156 may analyze the usual number of read or write operations performed on that node and respond to requests seeking that information. Compute analyzer 156 may also respond to queries about a specific compute entity 101 seeking information about whether a metric generated by that compute entity 101 is considered normal relative to its historical system profile.

Network analyzer 157 may analyze network metrics and network flows associated with compute entities 101 and/or network entities 105. For example, network analyzer 157 may examine processed data 111 and a time series of network flows that are derived from network metrics 107. Network analyzer 157 breaks down network traffic to get an in-depth understanding of how each compute entity 101 and/or network entity 105 interacts with the network and/or within system 100. Network analyzer 157 uses this information to build a historical network profile of each compute entity 101. The historical network profile built by network analyzer 157 enables it to respond to requests for information by providing information about specific compute entities 101, such as commonly accessed websites, average request size between the source and a destination, average response size between the source and destination, information about communication protocols, information about port range or the general range of ports that a given compute entity 101 makes requests to while communication with other nodes or compute entities 101, information about the average session duration (e.g., the average amount of time a node maintains a session with other nodes), and other information. Network analyzer 157 may also determine the nature of a network flow metric generated by a given compute entity 101 or network entity 105. When evaluating a network activity associated with a compute entity 101, network analyzer 157 uses a historic network profile to assess whether the current activity is typical or unusual but permissible. This historical context helps in distinguishing between a normal and potentially anomalous network behavior.

Timeline analyzer 158 may derive user behavior based on both system and network metrics. In some examples, timeline analyzer 158 specifies the probability of a machine or compute entity 101 being active at a given point in time. For example, if the user that typically operates compute entity 101A has a regular workday from Monday-Friday 9 am to 5 pm, and during this timeframe, the user logs into compute entity 101A and interacts with compute entity 101A to cause a certain level of network/CPU/storage activity to occur during these times. That user may also attend a meeting every Monday from 8 am to 9 am, so compute entity 101A can be expected to emit metrics consistent with a meeting (e.g., showing network activity and “Microsoft Teams” as an active application). Timeline analyzer 158 may also learn usage patterns and build a usage profile for each compute entity 101 within system 100. Timeline analyzer 158 may use the usage profile when responding to queries from other systems (e.g., threat detector 140) requesting, for example, “What is the probability of compute entity 101A being active on Tuesday at 1 am?” or ”Is it normal for compute entity 101B to engage in initiate an SSH session with compute entity 101C on Wednesday at 4 pm?”

Causality analyzer 159 evaluates historical data to identify or determine the originating or actual source of an event. For example, as described herein, threat scores tend to be lowered to reward good (usual and/or allowed) behavior and raised to penalize disallowed or unusual compute/network activity. However, in many cases, events associated with a node in the network might have been caused by, or occurred because of, another event. As an example, malware executing on compute entity 101A might result in multiple API calls for a service running on compute entity 101B, causing compute entity 101B to make multiple data access attempts for a database that might be running on compute entity 101C (i.e., malware on compute entity 101A>>service running on compute entity 101B>>database executing on compute entity 101C). As a result, compute entity 101C may show anomalous metrics, such as increased memory and CPU usage, which could cause the threat score for compute entity 101C to increase. If the threat score for compute entity 101C increases enough, system 100 could take actions to isolate compute entity 101C (e.g., if the threat score associated with compute entity 101C crosses a conditional policy threshold). And if the database on compute entity 101C is a core service within 100, the unavailability of that database might have wide ramifications and unintended consequences. To avoid such situations, causality analyzer 159 may evaluate processed data 111 and other information to determine and/or predict the actual source compute entity 101 of a given event, and associate some or all of the other events caused by the source event with the actual source compute entity 101. In the described example, that actual source compute entity is likely compute entity 101A. As a result, events caused by the malware executing on compute entity 101A will cause the threat score to increase for compute entity 101A, but not necessarily for other nodes (i.e., compute entities 101B and 101C). Accordingly, causality analyzer 159 may be used to ensure that threat score increases or decreases apply to the original or appropriate source compute entity 101 that is considered the root of the event.

In some examples, duplicate event padder 152 of threat detector 140 evaluates a stream or batch of processed data 111 from transformers 151 and determines whether the same events are repeated multiple times within the stream of processed data 111. In other words, duplicate event padder 152 may analyze a sequence of events to determine whether repeated events are actually caused by a single event. If each repeated event is treated as an independent event, such repeated events might effectively be false positives that inappropriately skew threat scores. For example, if a misconfigured service operating on a given compute entity 101 interacts with another device repeatedly in a way that causes the threat score for the compute entity 101 to increase, that repeated interaction could cause a threat score to increase quickly. Duplicate event padder 152 therefore operates to ensure that where repeated anomalous behavior of the same kind occurs (e.g., same 5-tuple repeatedly in a short duration) it discards duplicate events to ameliorate the cumulative effect of the repeated behavior on the threat score for that compute entity 101. However, for a stream of events associated with a compute entity 101 that are not related and are not considered duplicative, the threat score will still be adjusted as appropriate for that compute entity 101, potentially increasing quickly if a variety of different types of events occur that represent anomalous behavior.

Threat detector 140 uses the information developed and/or calculated by each of the analyzers (i.e., compute analyzer 156, network analyzer 157, timeline analyzer 158, and/or causality analyzer 159) to implement and/or enforce policies maintained by policy controller 180. Evaluator 153 of threat detector 140 evaluates processed data 111 and/or information received from each of the analyzers in preparation for determining a threat score. Scorer 154 uses the information generated by evaluator 153 to calculate a threat score for each of compute entities 101. Based on the calculated threat score, threat detector 140 may apply conditional policies maintained by policy controller 180. Applying conditional policies may involve configuring, modifying, or otherwise adjusting network entities 105 or other elements of system 100 to restrict or enable operations that can be performed by each of compute entities 101.

In FIG. 1, conditional policies are implemented through collection of metrics from compute entities 101 and network entities 105. The collected information is analyzed to understand behavior of compute entities 101 on the network. In such an example, a controller (e.g., threat detector 140) analyzes network communication, storage and compute attributes and metrics, and maintains a threat score for each source device in the network. Scores are updated over time based on events or actions (network communication, compute or storage usage) performed by compute nodes. Threat detector 140 may categorize actions in order to determine their effect on the threat score. According to one possible categorization scheme, actions are categorized as either “normal,” “allowed but anomalous,” and “restricted,” in increasing order of severity (i.e., increasing impact on threat score). In some examples, if one of compute entities 101 performs a “normal” action, meaning it is a “good” or “acceptable” behavior, the threat score for that compute entity 101 is lowered. If a compute entity 101 performs an “allowed but anomalous” action, the threat score for that compute entity 101 is increased. If a compute entity 101 performs a “restricted” action (meaning it might be considered “bad” or unacceptable behavior), the threat score for that compute entity 101 also tends to increase, and by an amount greater than for an “allowed but anomalous” action.

Threat detector 140 determines the category in which an action or event belongs based on historical actions performed by each compute entity 101. As an example, if compute entity 101A interacts with (e.g., opens a secure socket shell or SSH connection) with compute entity 101B almost every other day, then this behavior would be considered normal and categorized in the “normal” category. If policies maintained by policy controller 180 indicate that compute entity 101A is permitted to interact with compute entity 101C, but compute entity 101A hardly ever does interact with compute entity 101C (based on past behavior), then such an event would be considered allowed but anomalous, and the event would be categorized in the “allowed but anomalous” category. However, if policies maintained by policy controller 180 do not allow compute entity 101A to interact with compute entity 101C, but compute entity 101A nevertheless tried to interact with compute entity 101C and/or establish a connection with compute entity 101C, then this would be considered an event exhibiting restricted behavior, and the event would be categorized in the “restricted” category. In general, a “restricted” action occurs when a given compute entity 101 seeks to access a resource (or perform an operation) that network policies already forbid. When this occurs, systems within the network do not permit the access, so no restricted action occurs, but just the attempt to access a forbidden resource is useful information and is recorded (e.g., by increasing a threat score for the offending compute entity 101, or in other ways).

In general, malicious or negative actors, in their efforts to explore the network and/or exploit a compromised compute entity 101, will perform more unusual actions than a regular (i.e., authorized) user would, and will likely seek to access restricted resources more often than a regular user. Therefore, if attempts to access restricted resources increase a threat score significantly, the threat score associated with a compute entity 101 that has been taken over by a malicious actor will likely rise quickly and soon cross an established threshold. In the malicious actor's efforts to explore the network and gain access to resources, that malicious actor may end up performing actions that regular (i.e., legitimate) users of the system also do, but there will be fewer instances of such actions as compared to actions that constitute attempts to perform unauthorized, restricted, and/or unusual operations. Legitimate users will perform actions that are allowed and/or are normally performed on a day-to-day basis. Such actions are considered as “good” actions and would result in lowering the threat score (or at least not increasing the threat score). Legitimate actors will much more frequently perform “good” operations than “bad” operations, particularly compared to the number of bad operations that will likely be performed by a malicious actor. Legitimate users may occasionally seek to access restricted resources using a compute entity 101, and such attempts would also increase the threat score for that compute entity 101, but such events would be infrequent and therefore will not likely cause the threat score to cross a threshold that results in limitations placed on that compute entity 101.

When the threat score associated with a given compute entity 101 is below a certain threshold, that compute entity 101 is deemed to be not compromised, and is therefore considered safe to operate on the network. Operations subject to a conditional policy (i.e., “conditional policies”) are allowed in this situation, as are operations subject to a “regular policy” (i.e., a policy that is not conditional, which may typically involve operations that do not represent a potential security threat). When the threat score for that compute entity 101 rises above a threshold, operations performed pursuant to all regular policies are allowed. Therefore, normal operations are allowed, so regular work is not interrupted. However, operations governed by a conditional policy may be denied if the threat score value is above the defined threshold. In some examples, various conditional policies may have different threshold levels that are used to scrutinize a threat score for a given compute entity 101, such that a threat score may be high enough to cause one conditional policy to deny an operation, but low enough to cause another conditional policy to allow a different operation. Also, in some cases, all policies in a system may be considered conditional (i.e., no “regular policies”), such that all operations are subject to threat score scrutiny. In such a case, it is possible that a sufficiently high threat score could prevent a given compute entity 101 from performing any operations.

When system 100 of FIG. 1 is in operation, and in accordance with one or more aspects of the present disclosure, policy controller 180 may update policies that may apply in system 100. For instance, in an example that can be described in the context of FIG. 1, administrator computing device 190 detects input that it determines corresponds to information input by administrator 191. Administrator computing device 190 determines that the information pertains to compute or network policies to be applied in system 100. Administrator computing device 190 outputs information about the information to policy controller 180. Compute policy manager 181 within policy controller 180 evaluates the information and updates one or more compute policies that apply within system 100. Similarly, network policy manager 182 within policy controller 180 evaluates the information and updates one or more network policies that apply within system 100.

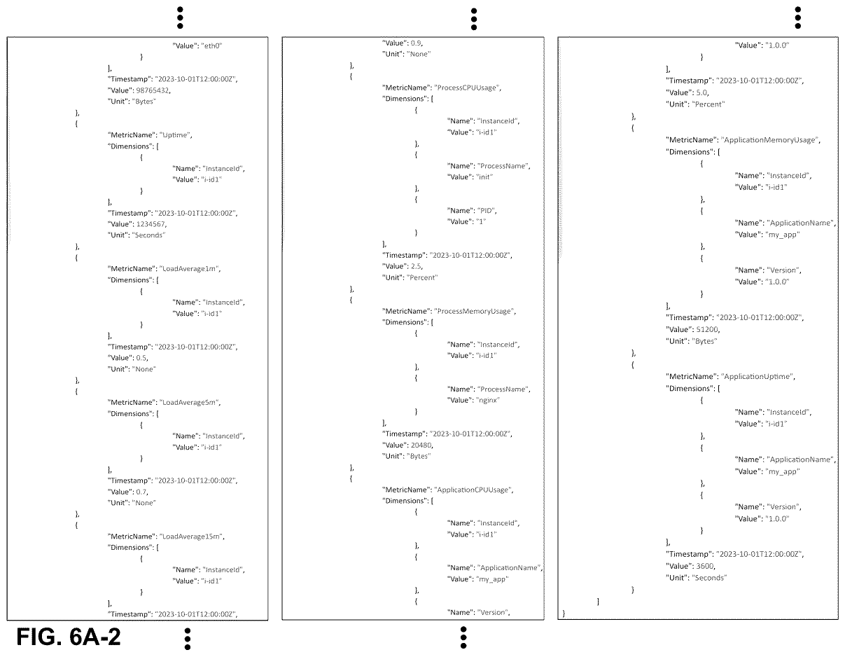

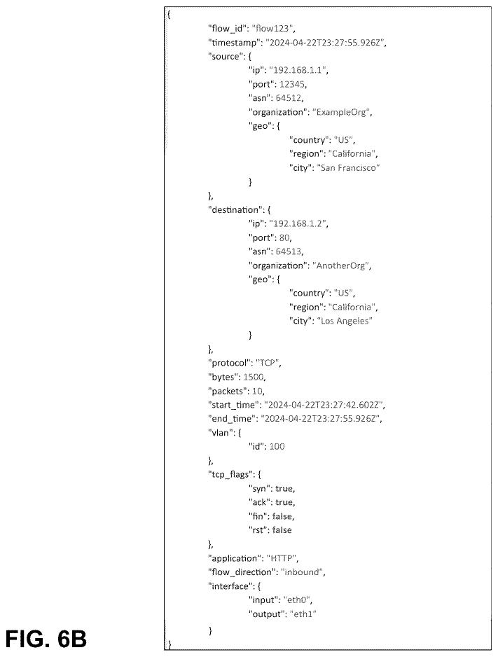

Compute entities 101 may output a stream of compute metrics 103. For instance, still with reference to FIG. 1, metric agents 102 within each of compute entities 101 collect a set of system-level metrics associated with each respective compute entity 101 and output a series of compute metrics 103. In some examples, metric agents 102 may be background services running within each of compute entities 101. In other examples, metric agents 102 may be a compute entity or third-party agent polling system metrics of each of the compute entities 101 within system 100. Metric agents 102 may publish compute metrics 103 to a messaging bus. Compute metrics 103 may include system level metrics providing information relating to CPU utilization, memory utilization, the number of processes executing on each of compute entities 101, the number of read and/or write operations performed at each of compute entities 101, a list of commonly accessed applications at a given compute entity 101, or other information. An example set of system metrics is illustrated in FIG. 6A.

Network entities 105 may output a stream of network metrics 107. For instance, still with reference to FIG. 1, flow exporters 106 (or similar logic) within at least some of network entities 105 collect a set of network flow information and/or information about the operation or utilization of each respective network entity 105. In some examples, the network entities 105 may represent the networking components of the network, and may include, for example smart session routers, or network switches that are capable of outputting information about network flows. Flow exporters 106 (or network entities 105) publish network flows to the messaging bus in the form of network metrics 107. Such network metrics 107 may include information such as DNS records, source address, destination address, port information, protocol information, information about the length of active sessions, the number of packets sent and/or dropped, the number of connections opened, and other information. An example set of network flow metrics is illustrated in FIG. 6B.

Threat detector 140 may construct profiles for each of compute entities 101. For instance, again referring to FIG. 1, compute entities 101 and network entities 105 occasionally, periodically, or continuously report usage metrics, events, and/or network flows (compute metrics 103 and network metrics 107) via a message bus. Transformer 151 correlates the compute metrics 103 and network metrics 107 with compute entities 101 and generates processed data 111 based on the compute metrics 103 and network metrics 107. Transformer 151 stores processed data 111 within storage system 170. Various analyzers (compute analyzer 156, network analyzer 157, timeline analyzer 158, causality analyzer 159) build behavior models based on historical data stored within storage system 170.

Threat detector 140 may calculate threat scores and enforce conditional policies. For instance, still referring to FIG. 1. threat detector 140 reads processed data 111 from transformer 151 from the message bus in batches. A batch might include all events seen during a timeframe (e.g., 30 seconds), and such a batch may contain any number (e.g., millions) of events. Duplicate event padder 152 of threat detector 140 evaluates each event and drops events that have been seen in the last few hours, to help reduce false positives. Evaluator 153 of threat detector 140 queries the analyzers to bucketize each event as “normal,” “allowed but anomalous,” or “restricted.” Evaluator 153 correlates each event with at least one of compute entities 101. Based on the categorization of each event in the batch of events and the previously constructed profile for each of compute entities 101, scorer 154 of threat detector 140 calculates a threat score (or adjusts the existing threat score) for each of compute entities 101.

In some examples, events are generated by entities 101 through a number of methods, each of which may enable correlation of events to the appropriate compute entity 101. For example, the metric agent may produce events for the compute entities. In this scenario, the metric agent will have ability to retrieve the IP addresses of the compute entities for which it is generating the events. In another example, the compute entities 101 can also report events directly. In this case, the events will include the source IP address of the compute entity that generated.

Threat detector 140 may enforce policies maintained by policy controller 180 based on calculated threat scores. For instance, again with reference to FIG. 1, threat detector 140 evaluates the updated threat score associated with each of compute entities 101. Threat detector 140 compares threat scores for each of compute entities 101 with a threshold threat score associated with each of the conditional policies maintained by policy controller 180. If a given compute entity 101 then seeks to perform an operation governed by a conditional policy, and that compute entity 101 has a threat score that exceeds the threshold threat score associated with the conditional policy, system 100 operates to prevent the compute entity 101 from performing the operation. Threat detector 140 may enforce the conditional policy by adjusting network infrastructure and/or configurations of one or more of network entities 105 within system 100 to enable or prohibit operations governed by the policy. In some examples, threat detector 140 may enforce a conditional policy by updating network entities 105, routers, and/or other network infrastructure to deny operations governed by conditional policies for specific compute entities 101. Threat detector 140 and/or system 100 may be configured to enable previously-denied operations for specific compute entity 101 after a predefined period of time or if the threat score for that compute entity 101 stays in the normal (e.g., below-threshold) range for a period of time, or if administrators 191 determine that the threat is resolved (e.g., after remediating the offending compute entity 101).

Although FIG. 1 is referenced herein in connection with the description of one or more specific examples, such examples are merely illustrative, and FIG. 1 can be used to provide support for other examples not specifically described herein. Accordingly, the one or more examples described herein with reference to FIG. 1 should not be construed to narrow the scope or spirit of the subject matter illustrated in FIG. 1 or any other illustration.

Further, although examples described herein apply conditional policies primarily to compute entities 101, conditional policies could also be applied to other elements of system 100, such as network entities 105. And although examples herein primarily describe the use of conditional policies in the context of network security, conditional policies can be applied using the same principles in other contexts, such as to regulating or managing bandwidth, utilization, resource consumption, or other aspects of a computing system or computer network.

Techniques described herein may provide certain technical advantages. For instance, by recognizing both that non-malicious actors will more often perform “normal” or “regular” actions (or make requests that are not anomalous) than a malicious actor, and that malicious actors will more often perform irregular or anomalous actions (or make anomalous requests) than non-malicious actors, it may be possible to effectively and quickly identify potential threats to a network or other infrastructure. Malicious actors that have somehow gained access to a trusted system will often attempt to explore a network and gain access to as much information and/or as many resources as possible, so malicious actors tend to overreach and perform actions that are not even attempted by normal users of that trusted system. Accordingly, by implementing conditional policies, network administrators may use these tendencies to effectively and quickly identify potential threats to a network or other infrastructure. Conditional policies may enable administrators to automate network setup without compromising on security.

Further, conditional policies may enable administrators to define the criticality of assets, making it easier to create blanket policies and ensure that an organization's critical assets are accessed only when it is safe to do so. By updating the threat score based on live traffic and events, conditional policies can block inappropriate actions very quickly and accurately, and in at least some cases, more quickly and accurately than conventional systems. Techniques described herein therefore may enable a fast, scalable way to protect access to critical assets, without burdening network administrators with manually evaluating requests and while ensuring that compute entities 101 that access critical assets are not compromised. These techniques may be considered an improvement over static network policies, in that conditional policies allow for specifying the criticality of assets in the policy itself, making it easier and safer to assign blanket policies to ease network setup.

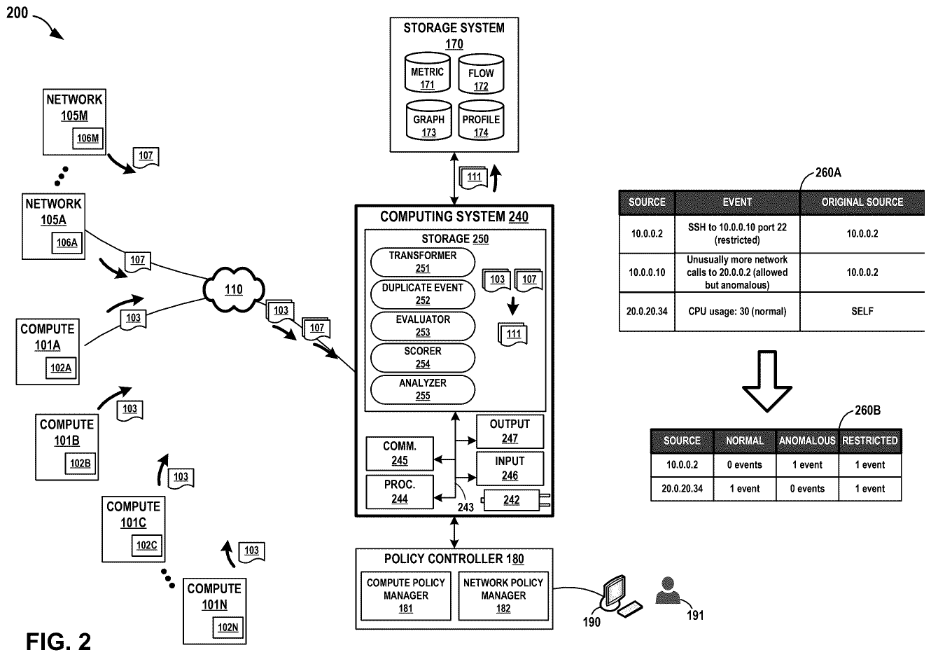

FIG. 2 is a block diagram illustrating an example system for applying conditional policies on a network, in accordance with one or more aspects of the present disclosure. System 200 of FIG. 2 includes many of the same elements of system 100 described in connection with FIG. 1, including compute entities 101, which are governed by conditional policies maintained by policy controller 180. In general, elements illustrated in FIG. 2 may correspond to earlier-described elements sharing the same reference numeral.

Also illustrated in FIG. 2 is a block diagram version of a computing system 240, which may be considered an example or alternative implementation of a combination of elements illustrated in FIG. 1. Specifically, computing system 240 may implement some or all of the features of transformer 151, threat detector 140, compute analyzer 156, network analyzer 157, timeline analyzer 158, and causality analyzer 159 of FIG. 1. Computing system 240 of FIG. 2 may operate in a manner similar to how the combination of transformer 151, threat detector 140, and analyzers 156, 157, 158, and 159 work together in FIG. 1. For example, computing system 240 may receive compute metrics 103 and network metrics 107 over a network 110 and generate processed data 111. Computing system 240 may also interact with storage system 170 and policy controller 180 (directly or over network 110). Computing system 240 may also use query analyzer module 255 to determine whether an operation, request, or other action by a given compute entity 101 is normal, allowed but anomalous, or restricted.

Computing system 240 is illustrated in FIG. 2 to facilitate a description of certain components, modules, and other aspects of a computing system that may implement aspects of a system for applying conditional policies. Computing system 240 is also illustrated in FIG. 2 to facilitate a description of how such a computing system may operate in accordance with techniques described herein. For ease of illustration, computing system 240 is depicted in FIG. 2 as a single computing system. However, in other examples, computing system 240 may be implemented through multiple devices or computing systems distributed across a data center, multiple data centers, multiple cloud networks, or otherwise. For example, separate computing systems may implement functionality described herein as being performed by each of the modules of computing system 240, including transformer module 251, duplicate event module 252, evaluator module 253, scorer module 254, and analyzer module 255. Alternatively, or in addition, modules illustrated in FIG. 2 as included within computing system 240 may be implemented through distributed virtualized compute instances (e.g., virtual machines, containers) of a data center, cloud computing system, server farm, and/or server cluster.

In FIG. 2, computing system 240 is shown with underlying physical hardware that includes power source 242, one or more processors 244, one or more communication units 245, one or more input devices 246, one or more output devices 247, and one or more storage devices 250. One or more of the devices, modules, storage areas, or other components of computing system 240 may be interconnected to enable inter-component communications (physically, communicatively, and/or operatively). In some examples, such connectivity may be provided by through communication channels, which may include a system bus (e.g., communication channel 243), a network connection, an inter-process communication data structure, or any other method for communicating data. Although computing system 240 of FIG. 2 may be considered an example implementation of threat detector 140 and other elements of FIG. 1, other implementations are possible.

In the example shown, power source 242 of computing system 240 may provide power to one or more components of computing system 240. Power source 242 may receive power from an alternating current (AC) power supply in a building, data center, or other location. In some examples, power source 242 may be or include a battery or a device that supplies direct current (DC). Power source 242 may have intelligent power management or consumption capabilities, and such features may be controlled, accessed, or adjusted by processors 244 to intelligently consume, allocate, supply, or otherwise manage power. Storage devices 250 may include transformer module 251, duplicate event module 252, evaluator module 253, scorer module 254, and analyzer module 255.

One or more processors 244 of computing system 240 may implement functionality and/or execute instructions associated with computing system 240 or associated with one or more modules illustrated herein and/or described herein. One or more processors 244 may be, may be part of, and/or may include processing circuitry that performs operations in accordance with one or more aspects of the present disclosure. Such processors may be mobile processors, desktop processors, server processors, compute nodes, virtualized processors, neural processing units or NPUs, graphics processing units or GPUs, and/or other types of processors or processing circuitry. Processors 244 may execute the instructions of one or more processes executing on computing system 240 and may implement functionality of such processes.

One or more communication units 245 of computing system 240 may communicate with devices external to computing system 240 by transmitting and/or receiving data, and may operate, in some respects, as both an input device and an output device. Communication units 245 may enable computing system 240 to communicate with other computing devices and systems using any appropriate communication protocol (e.g., TCP/IP) and over any appropriate medium. In some or all cases, one or more communication units 245 may communicate with other devices or computing systems over a network. For example, communication units 245 may enable computing system 240 to communicate (e.g., over network 110) with any other device illustrated in FIG. 2, such as storage system 170, policy controller 180, or any of compute entities 101 or network entities 105.

One or more input devices 246 may represent any input devices of computing system 240, and one or more output devices 247 may represent any output devices of computing system 240. Input devices 246 and/or output devices 247 may generate, receive, and/or process output from any type of device capable of outputting information to a human or machine. For example, one or more input devices 246 may generate, receive, and/or process input in the form of electrical, physical, audio, image, and/or visual input (e.g., peripheral device, keyboard, microphone, camera). Correspondingly, one or more output devices 247 may generate, receive, and/or process output in the form of electrical and/or physical output (e.g., peripheral device, actuator).

One or more storage devices 250 within computing system 240 may store information for processing during operation of computing system 240. Storage devices 250 may store program instructions and/or data associated with one or more of the modules described in accordance with one or more aspects of this disclosure. One or more processors 244 and one or more storage devices 250 may provide an operating environment or platform for such modules, which may be implemented as software, but may in some examples include any combination of hardware, firmware, and software. One or more processors 244 may execute instructions and one or more storage devices 250 may store instructions and/or data of one or more modules. The combination of processors 244 and storage devices 250 may retrieve, store, and/or execute the instructions and/or data of one or more applications, modules, or software. Processors 244 and/or storage devices 250 may also be operably coupled to one or more other software and/or hardware components, including, but not limited to, one or more of the components of computing system 240 and/or one or more devices or systems illustrated or described as being connected to computing system 240.

Transformer module 251 may perform functions corresponding to those performed by transformer 151 in FIG. 1, transforming a stream of compute metrics 103 and network metrics 107 (and flow information) into processed data 111. Duplicate event module 252 may perform functions corresponding to those described as being performed by duplicate event padder 152 in connection with FIG. 1, evaluating a stream or batch of processed data 111 and determining whether the same events are repeated multiple times. Duplicate event module 252 may operate to reduce any inappropriate effects of repeated behavior on a threat score for a given compute entity 101.

Evaluator module 253 may perform functions relating to evaluating a stream or batch of events and categorizing each in one of a number of categories, where those categories may include “normal,” “allowed but anomalous,” or “restricted” events. Evaluator module 253 may also correlate each event to one of compute entities 101. Scorer module 254 may use the results from evaluator module 253 to generate, for each of compute entities 101, a threat score that can be used to apply conditional policies within system 200.

To evaluate events or calculate a threat score, evaluator module 253 or scorer module 254 may engage services provided by analyzer module 255. Analyzer module 255 may perform functions similar to those of any or all of compute analyzer 156, network analyzer 157, timeline analyzer 158, and causality analyzer 159 described in connection with FIG. 1. Accordingly, analyzer module 255 may be a module that implements the combined functionality compute analyzer 156, network analyzer 157, timeline analyzer 158, and causality analyzer 159 of FIG. 1.

In FIG. 2, conditional policies can be implemented using computing system 240, which in this example may be considered an “Adaptive Policy Controller” that serves as a centralized system to collect metrics and other information from network entities 105 and compute entities 101, and use that information to analyze and understand behavior of compute entities 101 on the network. Computing system 240 may analyze network communication, storage and compute attributes and metrics, and maintain a threat score for each of the compute entities 101 within system 200.

In some examples, and in accordance with one or more aspects of the present disclosure, computing system 240 may build behavior models for each of compute entities 101. For instance, with reference to an example that can be described in the context of FIG. 2, compute entities 101 and network entities 105 occasionally, periodically, or continuously report usage metrics, events, and/or network flows (compute metrics 103 and network metrics 107) via a message bus and/or over network 110. Communication unit 245 of computing system 240 detects a series of signals and outputs information about the signals to transformer module 251 of computing system 240. Transformer module 251 correlates the compute metrics 103 and network metrics 107 with compute entities 101 and generates processed data 111. Transformer module 251 causes communication unit 245 of computing system 240 to output processed data 111 to storage system 170, where processed data 111 (or information about the processed data 111) is stored in various data stores (e.g., metrics data store 171, flow data store 172, graph data store 173, and profile data store 174). Duplicate event module 252 evaluates each event occurring within processed data 111 and drops events that are considered redundant. Analyzer module 255 analyzes processed data 111 and builds behavior models based on historical data stored within storage system 170.

When building behavior models and processing processed data 111, computing system 240 may perform a causality analysis to identify the actual source (i.e., one of compute entities 101) of a given event. For instance, again with reference to FIG. 2, causality logic within analyzer module 255 evaluates each event within a batch of processed data 111 to identify the correct or actual source of an event reported within the processed data 111. Table 260A illustrates an example result of such a causality analysis, where table 260A lists three events, with the initial source (or compute entity 101) of each event identified in the “source” column on the left side of table 260A, and the nature of the event identified in the middle column. In this example, analyzer module 255 determines that the second listed event in table 260A (i.e., “unusually more network calls”) actually originates from the compute entity at 10.0.0.2 (rather than the compute entity at 10.0.0.10). Accordingly, the “original source” for that second event is identified as 10.0.0.2 in the rightmost column of table 260A.

Computing system 240 may also categorize each event and use the categorization to calculate a threat score. For instance, still with reference to FIG. 2, computing system 240 queries analyzer module 255 for each event in table 260A and categorizes or bucketizes each event as being within one the “normal,” “allowed but anomalous,” or “restricted” category. Computing system 240 generates table 260B, which shows the events of table 260A grouped by original source (as determined by causality logic) and identifies the number of events within each category for that source. Evaluator module 253 of computing system 240 evaluates the information in tables 260A and 260B and outputs information about the evaluation to scorer module 254. Scorer module 254 calculates a threat score for each of compute entity 101 by performing a weighted calculation (as further described herein) for each of the two sources or compute entities 101 listed in table 260B. Based on the calculated threat scores, computing system 240 enforces policies maintained by policy controller 180. To enforce such policies, computing system 240 may adjust network infrastructure and/or one or more of network entities 105 to allow or disallow certain operations that one or more compute entities 101 seek to perform.

Modules illustrated in FIG. 2 (e.g., transformer module 251, duplicate event module 252, evaluator module 253, scorer module 254, and analyzer module 255) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

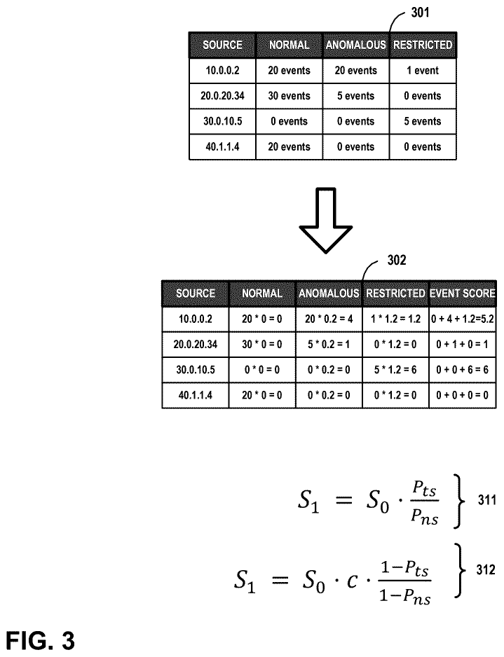

FIG. 3 is a conceptual diagram illustrating how event scores and threat scores can be calculated from a table of events, in accordance with one or more aspects of the present disclosure. The example of FIG. 3 is described herein in the context of operations performed by computing system 240 of FIG. 2. Event categorization table 301 of FIG. 3 is similar to table 260B of FIG. 2, but represents a different example with a larger number of events. In the example of FIG. 3, computing system 240 has identified four source compute entities as the original source of a number of events included in a batch of events. Each of those four compute entities are identified by their IP address in the left-hand column of event categorization table 301. Other categorization schemes are possible, but in FIG. 3, the three rightmost columns of table 301 identify the number of events, for each of the four source compute entities, that computing system 240 has characterized as “normal,” “allowed but anomalous” (abbreviated as “anomalous”), or “restricted.” In other words, the second through fourth columns of event categorization table 301 show the number of events in each category for each of the four source compute entities.

Event score table 302 illustrates how an event score is calculated for each source, using the information in event categorization table 301. To perform the event score calculation, computing system 240 weights, for each of the source compute entities, the number of events in each categorization (or bucket) shown in table 301. In the example of FIG. 3, the events in the “normal” category have a weight of zero, and the events in the “restricted” and “allowed but anomalous” categories both have positive weights, with the “restricted” category typically having a higher weight than those in the “allowed but anomalous” category. Specifically, in FIG. 3, the weighting for “normal” events is zero, “allowed but anomalous” events is 0.2, and “restricted” events is 1.2 (other appropriate weighting schemes are possible). As illustrated in event score table 302, these weights are multiplied by the number of events in each category for each source compute entity. The total event score for each source compute entity is shown in the rightmost column of event score table 302 and is calculated as the sum of the weighted values for each of the three categories.

To calculate a new threat score for a given source compute entity, computing system 240 uses the event score for that source compute entity to update the current running (or previous) threat score. In the example of FIG. 3, formulas 311 and 312 are used, but other ways to calculate a threat score from an event score are possible.

In formulas 311 and 312, “C” is the event score, as calculated in event score table 302. Formula 311 is used when the event score is zero, and formula 312 is used when the event score is greater than zero. In both formulas 311 and 312, S₁ is the new score, and S₀ is the old score. Pₜₛ refers to the probability of a malicious node successfully performing a normal, allowed event. This probability is typically very low. Pₙₛ refers to the probability of a non-infected node successfully performing a normal event. This probability is usually very high. In some examples, we may assume that Pₜₛ=0.2 and Pₙₛ=0.8.

S₁ may be bound between a lower and higher threshold. When computing system 240 determines that S₁ has exceeded the higher threshold, the corresponding source compute entity is classified as compromised. Conditional policies governing operations performed by that compute entity may thereafter be limited or denied. When computing system 240 determines that a later-calculated value of S has crossed below the lower threshold, the compute entity is no longer classified as compromised, and the conditional policy may enable the operations governed by the conditional policy (where those operations were previously denied as a result of an earlier high threat score). In some situations, such as after remediation of the compute entity at issue, the threat score value for that compute entity is reset to lower value, such as one.

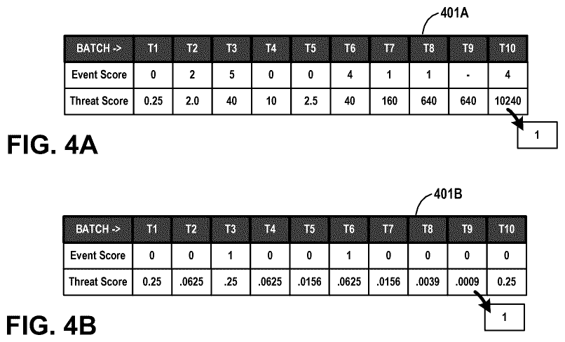

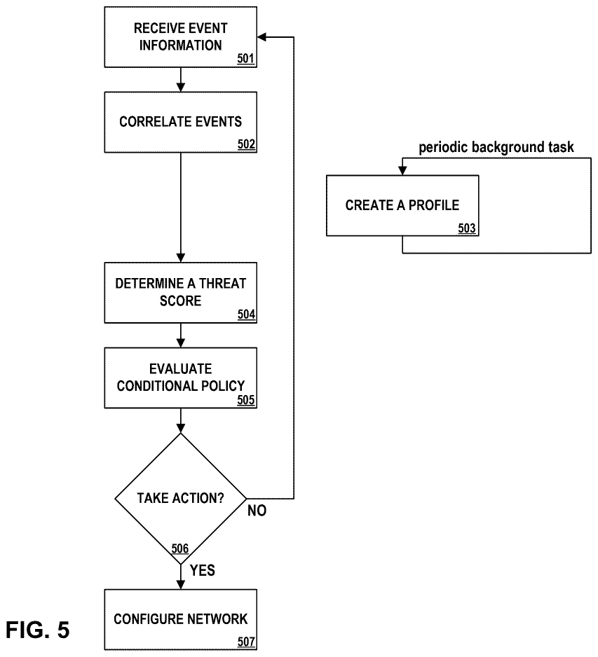

FIG. 4A illustrates a table showing how threat scores may change over the course of time, in accordance with one or more aspects of the present disclosure. For instance, in an example that can be described in the context of FIG. 2 and FIG. 4A, compute entity 101A is hosting a web service and has been compromised by a malicious actor. The malicious actor is seeking to use compute entity 101A to perform reconnaissance or discovery attacks to gain more information about potentially accessible networks. In the assumed example, the malicious actor runs a program to check for passwords stored in memory or to otherwise gather credentials at compute entity 101A (e.g., software like Mimikatz). The malicious actor may also execute a port scanning tool (e.g., Nmap) to scan for open ports in other machines or compute entities 101 on accessible networks. During this time, compute entity 101A may also receive and service normal web service requests.

In threat score table 401A, event scores may be calculated in a manner similar to that described in connection with FIG. 3. Threat scores may also be calculated based on event scores using formulas 311 and 312. In threat score table 401, event scores have been calculated, and those event scores are used to update threat scores for compute entity 101A over ten sequential batches occurring at times T1 to T10. After time T1, the threat score for compute entity 101A is assumed to be 0.25, and in the following timeframes associated with T2 through T10, the threat score in FIG. 4A fluctuates based on the event score for that timeframe. The calculated threat scores for the example of FIG. 4A are shown in the bottom row of threat score table 401.

Note that the web service hosted by compute entity 101A performs normally at times, so there are batches of good behavior signified by an event score of zero (e.g., batches T1, T4, T5). Those batches of good behavior result in a corresponding lowering of the threat score for compute entity 101A. However, since the malicious actor is trying to explore the network, there are batches in which events occur that are not historically “normal” for compute entity 101A. These events may involve CPU spikes at irregular hours by running Mimikatz, more network connections than usual due to Nmap, more incomplete 3-way-handshakes (TCP) since a port scan using Nmap will try communicating with a lot of closed ports. Also note that at T9, the malicious actor did not perform any action (e.g., possibly in an attempt to avoid detection), which in this example causes the threat score to remain the same at T9. But at T10, after detecting more anomalous events, computing system 240 calculates the threat score at a much higher value of 10240, which may cross an applicable conditional policy threshold. In that situation, computing system 240 takes certain actions, such as causing changes to the network so that compute entity 101A cannot communicate with other compute entities 101 in the network, or sending an alert to administrator computing device 190, which may be operated or monitored by administrator 191. After remediation to address the threat score, or after other conditions change, computing system 240 may reset the threat score following T10 to 1.

FIG. 4B illustrates a table showing a different example of how threat scores may change over the course of time, in accordance with one or more aspects of the present disclosure. In this different example, which can be described in the context of FIG. 2 and FIG. 4B, compute entity 101B has been working normally, but a misconfigured service executing on compute entity 101B repeatedly tries to access a restricted resource. As a result, computing system 240 observes multiple periodic network flows from compute entity 101B to port 2181 of compute entity 101C, which according to an applicable conditional policy, is a restricted or prohibited activity. Computing system 240 observes that at T3, T4, and T5, multiple network flow events occur where compute entity 101B is trying to establish a connection with port 2181 of compute entity 101C. However, duplicate event module 252 of computing system 240 disregards some of these events, and considers only the first unique event (identified by the applicable 5-tuple at T3). Duplicate event module 252 of computing system 240 disregards other events at T3, T4, and T5, so those events do not increase the threat score in this example (the event scores at T4 and T5 are zero in this example). Note that at T9, computing system 240 calculates the threat score as 0.009, which is below the lower threshold for an applicable conditional policy, so computing system 240 may reset the threat score for compute entity 101B to 1. Based on normal events occurring at T10, the threat score drops from 1 to 0.25 at T10.

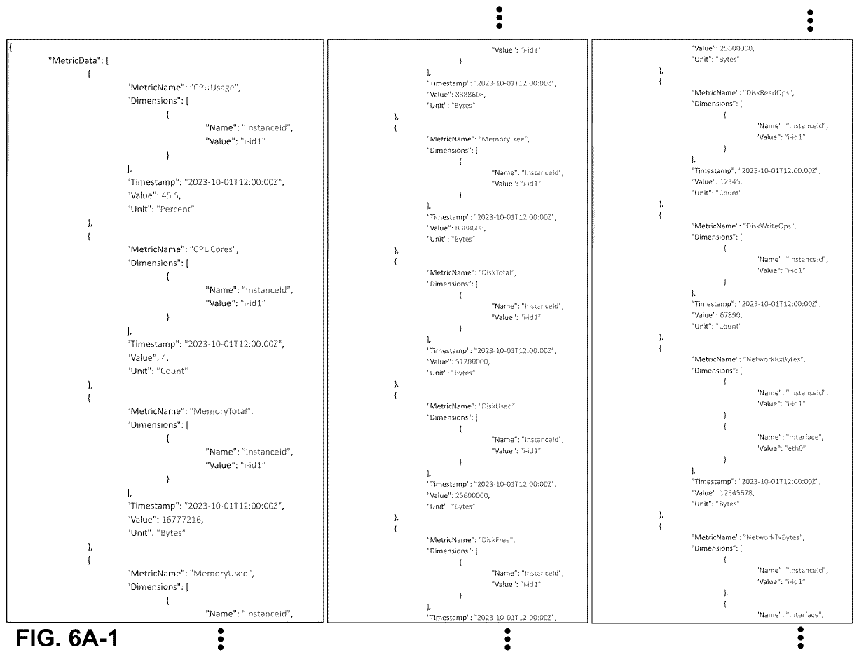

FIG. 5 is a flow diagram illustrating operations performed by an example computing system 240, in accordance with one or more aspects of the present disclosure. FIG. 5 is described below within the context of computing system 240 of FIG. 2. In other examples, operations described in FIG. 5 may be performed by one or more other components, modules, systems, or devices. Further, in other examples, operations described in connection with FIG. 5 may be merged, performed in a difference sequence, omitted, or may encompass additional operations not specifically illustrated or described.

In the process illustrated in FIG. 5, and in accordance with one or more aspects of the present disclosure, computing system 240 may receive information about events occurring on a network (501). For example, with reference to FIG. 2, computing system 240 receives compute metrics 103 from compute entities 101 and network metrics 107 from network entities 105.

Computing system 240 may correlate the events to each of a plurality of compute entities on the network (502). For example, transformer module 251 of computing system 240 processes the compute metrics 103 and network metrics 107 to generate processed data 111. Duplicate event module 252 may filter out redundant processed data 111. Analyzer module 255 evaluates flow data, performs a causation analysis, and/or performs other operations to determine which of compute entities 101 is the source for each event reported within processed data 111 (e.g., see table 260A).

Computing system 240 may create a profile, based on the correlated events, for each of the plurality of compute entities (503). For example, analyzer module 255 analyzes metrics and timeline information to determine normal operations performed by each of compute entities 101. In some examples, analyzer module 255 performs this task as a background task that runs periodically or in regular intervals. Accordingly, in FIG. 5, creating a profile is shown separately from the main flow diagram in FIG. 5, to signify that it operates as a periodic background task operating at regular intervals. In other examples, analyzer module 255 may create a profile as a background task occasionally or continually (i.e., rather than at “regular” intervals), or on demand.

Computing system 240 may determine, based on the profile and a batch of new events, a threat score for each of the plurality of compute entities (504). For example, evaluator module 253 creates a table of events for each source entity associated with an event (e.g., see table 260B or event categorization table 301). Scorer module 254 uses the table to calculate an event score for each of compute entities 101 (e.g., see event score table 302). Scorer module 254 uses the event score to calculate a threat score for each of compute entities 101. In one example, scorer module 254 uses a method similar to that described in connection with FIG. 3.

Computing system 240 may evaluate, based on the threat score for a compute entity of the plurality of compute entities, a conditional policy governing allowed operations for the compute entity (505). For example, scorer module 254 compares the calculated threat score for one of the compute entities 101, such as compute entity 101A, to a threshold defined by a conditional policy maintained by policy controller 180. If scorer module 254 determines that the calculated threat score has crossed a threshold associated with the conditional policy, scorer module 254 may cause computing system 240 to take action to enforce the policy (YES path from 506). Taking action may involve restricting operations performed by compute entity 101A, where a threat score exceeds a threshold. Taking action may also involve enabling operations performed by compute entity 101A, such as where a previously high threat score has crossed back below a threshold. In some cases, scorer module 254 may determine that no action is required (NO path from 506).

Computing system 240 may configure the network, based on the evaluation, to enforce the conditional policy for the compute entity (507). For example, computing system 240 causes communication unit 245 to output control signals to one or more other systems within system 200, instructing such other systems to take an action to implement or enforce the conditional policy. In one example, computing system 240 sends control signals, based on the evaluation of the conditional policy, to a specific network entity 105, where the control signals instruct that network entity 105 to modify its configurations and/or modify its operation to deny an operation sought to be performed by compute entity 101A that is governed by the conditional policy. The specific network entity 105 receives the signals and determines that the signals include instructions for modifying configurations or changing its operation, and in response, that network entity 105 makes such changes and/or modifies its operation. Accordingly, computing system 240 controls the operation of another system (e.g., one or more of network entities 105) based on a calculated threat score.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

In the preceding description, references may be occasionally made to “some examples.” In this disclosure, a reference to “some examples” is intended to mean a subset of all of the possible examples supported by this disclosure. Also, different references to “some examples” are not always a reference to the same subset of examples.

The disclosures of all publications, patents, and patent applications referred to herein are hereby incorporated by reference. To the extent that any material that is incorporated by reference conflicts with the present disclosure, the present disclosure shall control.

For ease of illustration, only a limited number of devices (e.g., compute entities 101, network entities 105, transformer 151, threat detector 140, storage system 170, policy controller 180, administrator computing device 190, computing system 240, as well as others) are shown within the illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The illustrations included herein depict at least one example implementation of an aspect of this disclosure. The scope of this disclosure is not, however, limited to such implementations. Accordingly, other example or alternative implementations of systems, methods or techniques described herein, beyond those illustrated, may be appropriate in other instances. Such implementations may include a subset of the devices and/or components included in the illustrations and/or may include additional devices and/or components not specifically illustrated.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced illustrations in order to avoid obscuring such concepts.

Accordingly, although one or more implementations of various systems, devices, and/or components may be described with reference to specific illustrations, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated herein may alternatively be implemented as part of another device or component not shown in such illustrations. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner. References herein to “real time” or equivalent phrases are intended to encompass near-real time or seemingly near-real time, such as from the perspective of a reasonable human observer

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, graphics processing units (GPUs), application specific integrated circuits (ASICs), field programmable logic arrays (FPGAs), quantum processors, or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including, to the extent appropriate, a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A computing system comprising processing circuitry and a storage device, wherein the processing circuitry has access to the storage device and is configured to comprising:
receive information about events occurring on a network;
correlate each of the events to one of a plurality of compute entities on the network;
create, based on the correlated events, a profile for each of the plurality of compute entities;
determine, for each compute entity of the plurality of compute entities, a threat score, wherein the threat score for each of the plurality of compute entities is based on the profile for each respective compute entity;
evaluate, based on the threat score for a compute entity of the plurality of compute entities, a conditional policy governing allowed operations for the compute entity; and
configure, based on the evaluation, the network to enforce the conditional policy for the compute entity.

2. The computing system of claim 1, wherein to receive information about events occurring on the network, the processing circuitry is further configured to:
receive metrics from each of the plurality of compute entities; and
receive metrics and flow data from each of a plurality of network entities on the network.

3. The computing system of claim 2, wherein to correlate each of the events, the processing circuitry is further configured to:
correlate the flow data to identify, for each event, a source compute entity of the plurality of compute entities.

4. The computing system of claim 3, wherein to correlate the flow data to identify the source compute entity, the processing circuitry is further configured to:
perform a causality analysis to identify, for each event, an original source of the event.

5. The computing system of claim 1, wherein to correlate each of the events, the processing circuitry is further configured to:
perform a duplicate event analysis to omit redundant events.

6. The computing system of claim 1, wherein to create the profile, the processing circuitry is further configured to:
create a profile that enables the computing system to categorize an event as one of normal, allowed but anomalous, or restricted.

7. The computing system of claim 1, wherein to determine, for each compute entity of the plurality of compute entities, the threat score, the processing circuitry is further configured to:
perform a calculation in which allowed but anomalous events are weighted to increase threat scores more than normal events and in which restricted events are weighted to increase threat scores more than allowed but anomalous events.

8. The computing system of claim 1, wherein to determine, for each compute entity of the plurality of compute entities, the threat score for the compute entity, the processing circuitry is further configured to:
calculate an event score for each of a subset of the plurality of compute entities based on a batch of events; and
update the threat score for each of the subset of the plurality of compute entities based on the event score.

9. The computing system of claim 1, wherein to determine, for each compute entity of the plurality of compute entities, the threat score, the processing circuitry is further configured to:
determine a likelihood that each of the plurality of compute entities is operated by a malicious actor.

10. The computing system of claim 1, wherein to evaluate the conditional policy, the processing circuitry is further configured to:
compare the threat score for the compute entity to a threshold value.

11. The computing system of claim 1, wherein to configure the network, the processing circuitry is further configured to:
modify network infrastructure to restrict operations, performed by the compute entity, that are governed by the conditional policy.

12. The computing system of claim 1, wherein to configure the network, the processing circuitry is further configured to:
modify network infrastructure to enable operations, performed by the compute entity, that are governed by the conditional policy.

13. The computing system of claim 1, wherein to configure the network, the processing circuitry is further configured to:
send control signals, based on the evaluation of the conditional policy, to a network entity on the network, the control signals instructing the network entity to modify its configuration to deny an operation governed by the conditional policy.

14. A method comprising:
receiving, by a computing system, information about events occurring on a network;
correlating, by the computing system, each of the events to one of a plurality of compute entities on the network;
creating, by the computing system and based on the correlated events, a profile for each of the plurality of compute entities;
determining, by the computing system and for each compute entity of the plurality of compute entities, a threat score, wherein the threat score for each of the plurality of compute entities is based on the profile for each respective compute entity;
evaluating, by the computing system and based on the threat score for a compute entity of the plurality of compute entities, a conditional policy governing allowed operations for the compute entity; and
configuring, by the computing system and based on the evaluation, the network to enforce the conditional policy for the compute entity.

15. The method of claim 14, wherein receiving information about events occurring on the network includes:
receiving metrics from each of the plurality of compute entities; and
receiving metrics and flow data from each of a plurality of network entities on the network.

16. The method of claim 15, wherein correlating each of the events includes:
correlating the flow data to identify, for each event, a source compute entity of the plurality of compute entities.

17. The method of claim 16, wherein correlating the flow data to identify the source compute entity includes:
performing a causality analysis to identify, for each event, an original source of the event.

18. The method of claim 14, wherein correlating each of the events includes:
performing a duplicate event analysis to omit redundant events.

19. The method of claim 14, wherein creating the profile includes:
creating a profile that enables the computing system to categorize an event as one of normal, allowed but anomalous, or restricted.

20. Non-transitory computer-readable media comprising instructions that, when executed, cause processing circuitry of a computing system to:
receive information about events occurring on a network;
correlate the events to each of a plurality of compute entities on the network;
create a profile, based on the correlated events, for each of the plurality of compute entities;
determine, based on the profile and a batch of new events, a threat score for each of the plurality of compute entities;
evaluate, based on the threat score for a compute entity of the plurality of compute entities, a conditional policy governing allowed operations for the compute entity; and
configure the network, based on the evaluation, to enforce the conditional policy for the compute entity.
